(19) United States
(12) Patent Application Publication
(10) Pub. No.: US 2026/0211097 A1
(43) Pub. Date: Jul. 23, 2026

(54) ESTIMATING DEVICE, ESTIMATING METHOD, AND RECORDING MEDIUM

(71) Applicant: Panasonic Intellectual Property Management Co., Ltd., Osaka (JP)

(72) Inventors: Nobuyuki SHIRAKI, Hokkaido (JP); Takeshi NAKAYAMA, Hyogo (JP); Shoichi IIZUKA, Osaka (JP); Naoki HONMA, Iwate (JP); Tomonori ITO, Iwate (JP); Takumi SHIMOFUSA, Iwate (JP)

(21) Appl. No.: 19/142,886

(22) PCT Filed: Dec. 19, 2023
(86) PCT No.: PCT/JP2023/045521

§ 371 Date: Jun. 24, 2025

(30) Foreign Application Priority Data
Dec. 27, 2022 (JP) 2022-209187

(51) Int. Cl. G01S 13/08; G01S 7/03

(52) U.S. Cl. CPC G01S 13/08; G01S 7/03

(57) ABSTRACT

An estimating device including: a transmitter that processes and transmits a multicarrier signal to a transmission antenna; a transmission antenna including M transmission antenna elements; a reception antenna including N reception antenna elements; a receiver that measures reception signals for a first period; a first complex transfer function calculator that calculates a plurality of first complex transfer functions indicating propagation characteristics between each transmission antenna element and each reception antenna element from a plurality of reception signals measured in the first period for each subcarrier of the modulation signal; and a second complex transfer function calculator that calculates a second complex transfer function by dividing all elements based on the plurality of first complex transfer functions by a direct wave component.

### TECHNICAL FIELD

The present disclosure relates to an estimating device, an estimating method, and a program for accurately estimating information related to a living body.

### BACKGROUND ART

A method that uses radio signals is being considered as a method for knowing the position of a person (see for example, Patent Literature (PTL) 1 to 4). PTL 1, 2, and 3 disclose techniques of estimating the position and state of a person that is a detection target by analyzing a component including a Doppler shift using difference calculation. PTL 4 and 5 disclose Doppler sensors that use orthogonal frequency division multiplexing (OFDM) signals.

### CITATION LIST

### Patent Literature

[PTL 1] Japanese Unexamined Patent Application Publication No. 2015-117972
[PTL 2] Japanese Unexamined Patent Application Publication No. 2017-129558
[PTL 3] Japanese Unexamined Patent Application Publication No. 2018-008021
[PTL 4] Japanese Unexamined Patent Application Publication No. 2012-088279
[PTL 5] Japanese Unexamined Patent Application Publication No. 2012-137340
[PTL 6] Japanese Unexamined Patent Application Publication No. 2006-157663
[PTL 7] Japanese Unexamined Patent Application Publication No. 2001-144722

### Non Patent Literature

[NPL 1] H. Yamada, M. Ohmiya, Y. Ogawa and K. Itoh, “Superresolution techniques for time-domain measurements with a network analyzer,” in IEEE Transactions on Antennas and Propagation, vol. 39, no. 2, pp. 177-183, February 1991

### SUMMARY OF INVENTION

### Technical Problem

With the conventional methods, it is difficult to more accurately estimate information related to a living body.

The present disclosure is conceived in view of the above-described circumstances, and provides an estimating device capable of more accurately estimating information related to a living body.

### Solution to Problem

In order to achieve the above object, an estimating device according to one aspect of the present disclosure includes: a transmission signal generator that generates a multicarrier signal obtained by modulating a plurality of subcarrier signals; a transmission antenna including M transmission antenna elements, where M is a natural number greater than or equal to 1; a transmitter that causes the transmission antenna to transmit the multicarrier signal, by processing and outputting the multicarrier signal to the transmission antenna; a reception antenna including N reception antenna elements, where N is a natural number greater than or equal to 1; a receiver that measures, for a first period equivalent to a cycle derived from an activity of a living body, a plurality of reception signals which are received by each of the N reception antenna elements and include a reflected signal which is the multicarrier signal transmitted from each of the M transmission antenna elements that has been reflected or dispersed by the living body; a first complex transfer function calculator that calculates, for each of a plurality of subcarriers to which the plurality of subcarrier signals correspond, a plurality of first complex transfer functions indicating a propagation characteristic between a transmission antenna element and a reception antenna element in each of M×N combinations which are combinations of each of the M transmission antenna elements and each of the N reception antenna elements, using the plurality of reception signals measured by the receiver in the first period; and a second complex transfer function calculator that calculates a second complex transfer function by dividing all elements based on the plurality of first complex transfer functions by a direct wave component extracted using one or more elements based on the plurality of first complex transfer functions, the direct wave component having arrived not via the living body from the plurality of reception signals.

An estimating method according to one aspect of the present disclosure includes: generating a multicarrier signal obtained by modulating a plurality of subcarrier signals; causing a transmission antenna to transmit the multicarrier signal, by processing and outputting the multicarrier signal to the transmission antenna, the transmission antenna including M transmission antenna elements, where M is a natural number greater than or equal to 1; measuring, for a first period equivalent to a cycle derived from an activity of a living body, a plurality of reception signals which are received by each of N reception antenna elements included in a reception antenna and which include a reflected signal which is the multicarrier signal transmitted from each of the M transmission antenna elements that has been reflected or dispersed by the living body, where N is a natural number greater than or equal to 1, where at least one of M or N is greater than or equal to 2; calculating, for each of a plurality of subcarriers to which the plurality of subcarrier signals correspond, a plurality of first complex transfer functions indicating a propagation characteristic between a transmission antenna element and a reception antenna element in each of M×N combinations which are combinations of each of the M transmission antenna elements and each of the N reception antenna elements, using the plurality of reception signals measured in the first period; and calculating a second complex transfer function by dividing all elements based on the plurality of first complex transfer functions by a direct wave component extracted using one or more elements based on the plurality of first complex transfer functions, the direct wave component having arrived not via the living body from the plurality of reception signals.

It should be noted that these general and specific aspects may be implemented using a system, an integrated circuit, a computer program, or a computer-readable recording medium such as a CD-ROM, or any combination of an apparatus, a system, a method, an integrated circuit, a computer program, or a recording medium.

### Advantageous Effects of Invention

According to the present disclosure, it is possible to more accurately estimate information related to a living body.

### BRIEF DESCRIPTION OF DRAWINGS

FIG. 1 is a block diagram illustrating an example of a configuration of an estimating device.

FIG. 2 is a schematic diagram illustrating that the phase of a reception signal changes due to frequency and distance.

FIG. 3 is a schematic diagram illustrating the relationship between a phase error and a channel.

FIG. 4 is a schematic diagram illustrating the relationship between frequency and phase difference slope.

FIG. 5 is a schematic diagram illustrating phases of a time domain living body component transfer function matrix.

FIG. 6 is a schematic diagram illustrating the position of a living body which is limited by the relationship between the living body, a transmission antenna element, and a reception antenna element, and by a third distance.

FIG. 7 is a schematic diagram illustrating the estimation of the position of a living body by using a plurality of reception antenna elements.

FIG. 8 is a flowchart illustrating the estimation process by an estimating device.

FIG. 9 is a flowchart illustrating a second complex transfer function calculation process.

FIG. 10 is a flowchart illustrating a third complex transfer function calculation process.

FIG. 11 is a flowchart illustrating a ranging process.

### DESCRIPTION OF EMBODIMENTS

### (Underlying Knowledge Forming Basis of the Present Disclosure)

A method that uses radio signals is being considered as a method for knowing the position of a person.

For example, PTL 1 and 2 disclose transmitting a radio signal over a predetermined area, receiving, using antennas, the radio signal reflected by a detection target, and estimating a complex transfer function between transmission and reception antennas. A complex transfer function is a function of a complex number representing a relationship between input and output, and, here, represents propagation characteristics between transmission and reception antennas. The number of elements of the complex transfer function is equivalent to the product of the number of transmission antennas and the number of reception antennas. In addition, PTL 3 discloses estimating the posture of a living body by using a radar cross-section (RCS) calculated from received power, with the same configuration as in PTL 2. RCS is an index indicating the area of an object that reflected a transmission wave, and the RCS of a living body changes in various ways according to the posture.

PTL 1 discloses that it is possible to know the position or state of a person that is a detection target by analyzing a component including a Doppler shift, using Fourier transform. More specifically, the temporal change of an element of a complex transfer function is recorded, and the temporal waveform thereof is Fourier-transformed. Through biological activity such as respiration or heartbeat, a living body such as a person exerts a small Doppler effect on the reflected wave. Therefore, a component including a Doppler shift includes the influence of the person. On the other hand, a component that does not include a Doppler shift is a component that is not influenced by the person, that is, a component corresponding to a reflected wave from a fixed object or a direct wave between transmission and reception antennas. Specifically, it is possible to know the position or state of a person that is a detection target, by using a component included in a predetermined frequency range in a Fourier-transformed waveform.

PTL 2 discloses a method of recording a temporal change in an element of a complex transfer function, and extracting a component including a small Doppler shift including the influence of a living body by analyzing difference information of the temporal change. Specifically, it is possible to know the position or state of a person that is a detection target by using the difference information.

In contrast, PTL 3 discloses an OFDM Doppler radar that transmits a pulse using an OFDM signal, and detects a Doppler shift caused by a traveling body that is a target. Furthermore, PTL 4 discloses, with regard to an OFDM Doppler radar, a high-speed processing method that does not require Fourier transform.

Furthermore, PTL 6 and 7 disclose techniques for improving the accuracy of estimation of complex transfer functions between transmission and reception antennas, by transmitting an OFDM signal. PTL 5 discloses that received noise components can be reduced by averaging complex transfer functions on a subcarrier basis, and PTL 7 discloses that received noise components can be reduced by selecting a subcarrier having the maximum reception power.

However, in the methods in PTL 1, 2, and 3, non-modulated waves are transmitted, and thus it is difficult to make use of commercially available devices, and dedicated hardware is required. Specifically, it is not possible to use communication devices that are currently widely used, and thus a user needs to additionally provide dedicated hardware aside from an existing communication device.

Furthermore, in order to obtain sufficient accuracy with the methods in PTL 4 and 5, it is necessary to make pulses steep, which requires a wide frequency band. As such, the cost of hardware is more expensive compared to communication devices for public use.

In the technique in NPL 1, by transmitting and receiving signals having a plurality of frequencies using a measuring device such as a network analyzer, it is possible to estimate the time of flight (ToF) and distance, which can be computed from the ToF, between a transmission antenna and a reception antenna. As in a ranging sensor that uses a frequency modulated continuous wave (FMCW) radar, this makes use of the property in which, when two signals having different frequencies are transmitted at the same phase, the phase received by the reception antenna changes depending on the frequency difference between signals and the propagation distance between the antennas. The technique in NPL 1 improves resolution by performing ToF estimation using the multiple signal classification (MUSIC) method. However, it is necessary for the transmission side and reception side to either operate with the same reference frequency or be synchronized with high accuracy, and thus the technique cannot be used in household appliances connected via, for example, a wireless LAN. Furthermore, only the distance between antennas can be estimated, and, for example, the distance to a living body that is not equipped with a special device cannot be estimated.

In view of the above, the inventors arrived at inventing, with high accuracy and low cost by using an existing transmission device, an estimating device, etc., capable of estimating information related to a living body with higher accuracy, using a multicarrier radio signal represented by an OFDM signal. Note that information related to a living body is, for example, the distance from the estimating device to the living body, the direction from the estimating device to the living body, the position of the living body, an identifier of the living body, and so on.

An estimating device according to a first aspect of the present disclosure includes: a transmission signal generator that generates a multicarrier signal obtained by modulating a plurality of subcarrier signals; a transmission antenna including M transmission antenna elements, where M is a natural number greater than or equal to 1; a transmitter that causes the transmission antenna to transmit the multicarrier signal, by processing and outputting the multicarrier signal to the transmission antenna; a reception antenna including N reception antenna elements, where N is a natural number greater than or equal to 1; a receiver that measures, for a first period equivalent to a cycle derived from an activity of a living body, a plurality of reception signals which are received by each of the N reception antenna elements and include a reflected signal which is the multicarrier signal transmitted from each of the M transmission antenna elements that has been reflected or dispersed by the living body; a first complex transfer function calculator that calculates, for each of a plurality of subcarriers to which the plurality of subcarrier signals correspond, a plurality of first complex transfer functions indicating a propagation characteristic between a transmission antenna element and a reception antenna element in each of M×N combinations which are combinations of each of the M transmission antenna elements and each of the N reception antenna elements, using the plurality of reception signals measured by the receiver in the first period; and a second complex transfer function calculator that calculates a second complex transfer function by dividing all elements based on the plurality of first complex transfer functions by a direct wave component extracted using one or more elements based on the plurality of first complex transfer functions, the direct wave component having arrived not via the living body from the plurality of reception signals.

With this, a second complex transfer function can be calculated in which components corresponding to frequency phase error and at least one of the following are inhibited: (1) clock fluctuations between a transmission device including a transmission signal generator that transmits from a transmission antenna and a transmitter, and a reception device including a receiver that receives via a reception antenna, or (2) timing fluctuations in digital-to-analog conversion of the transmission signal or analog-to-digital conversion of the reception signal. Accordingly, information related to a living body can be obtained quickly and accurately by using radio signals.

With this configuration, a living body radar can be realized by repurposing an existing communication device by using a multicarrier signal such as an OFDM signal as a transmission signal. For example, OFDM reception devices are already widely used as mobile phones, television broadcast reception devices, wireless LAN devices, and so on, and are lower in cost than when non-modulated signals are used.

An estimating device according a second aspect of the present disclosure is the estimating device according to the first aspect, wherein the one or more elements used for extraction of the direct wave component include two or more elements respectively corresponding to two or more subcarriers that are adjacent in frequency among the plurality of subcarriers.

Therefore, components corresponding to at least one of the following can be more effectively inhibited: (1) clock fluctuations between a transmission device including a transmission signal generator that transmits from a transmission antenna and a transmitter, and a reception device including a receiver that receives via a reception antenna, or (2) timing fluctuations in digital-to-analog conversion of the transmission signal or analog-to-digital conversion of the reception signal.

An estimating device according to a third aspect of the present disclosure is the estimating device according to the second aspect, wherein the direct wave component is an average value of one element based on the plurality of first complex transfer functions and the two or more elements.

An estimating device according to a fourth aspect of the present disclosure is the estimating device according to the second aspect, wherein the direct wave component is a direct wave transfer function which is a channel component of a direct wave and is calculated by multiplying an eigenvector by the plurality of first complex transfer functions, the eigenvector being, among pairs of eigenvalues and eigenvectors calculated by performing Eigendecomposition of a correlation matrix of one element based on the plurality of first complex transfer functions and the two or more elements, an eigenvector paired with a maximum eigenvalue.

An estimating device according to a fifth aspect of the present disclosure is the estimating device according to any one of the first to fourth aspects, further including: a third complex transfer function calculator that calculates a third complex transfer function in which frequency phase errors in the plurality of subcarriers are corrected, based on (i) a distance between the transmission antenna element and the reception antenna element and (ii) the plurality of first complex transfer functions.

An estimating device according to a sixth aspect of the present disclosure is the estimating device according to any one of the first to fourth aspects, further including: a third complex transfer function calculator that calculates a third complex transfer function in which frequency phase errors in the plurality of subcarriers are corrected, based on (i) a distance between the transmission antenna element and the reception antenna element and (ii) a reference complex transfer function matrix which is a complex transfer function measured for a second period.

An estimating device according to a seventh aspect of the present disclosure is the estimating device according to the fifth or sixth aspect, further including: a living body correlation matrix calculator that successively records a plurality of third complex transfer functions, each of which is the third complex transfer function, in time series which is an order in which the plurality of third complex transfer functions are measured, and calculates a living body correlation matrix by extracting a component related to the living body from the plurality of third complex transfer functions; and a ranging unit that estimates, using the living body correlation matrix, a third distance that is a sum of a first distance between the transmission antenna and the living body, and a second distance between the reception antenna and the living body.

Accordingly, the third distance can be more accurately calculated.

An estimating device according to an eighth aspect of the present disclosure is the estimating device according to the seventh aspect, wherein the living body correlation matrix calculator: calculates a correlation matrix of the third complex transfer function; calculates a first vector by vectorizing a lower triangular matrix excluding diagonal terms of the correlation matrix; and calculates the living body correlation matrix by extracting a component related to the living body from the first vector.

Accordingly, the third distance can be more accurately calculated.

An estimating device according to a ninth aspect of the present disclosure is the estimating device according to the seventh or eighth aspect, wherein the ranging unit estimates the third distance using any one of a multiple signal classification (MUSIC) method, a beamformer method, or a Capon method.

An estimating device according to a tenth aspect of the present disclosure is the estimating device according to any one of the seventh to ninth aspects, wherein at least one of the M transmission antenna elements or the N reception antenna elements includes two antenna elements, and the estimating device further includes a position estimator that calculates two or more ellipses in which positions of the M transmission antenna elements and the N reception antenna elements are foci and a length of a major axis is the third distance, and estimates an intersection of the two or more ellipses as a position of the living body.

For this reason, the position of the living body relative to the estimating device can be more accurately estimated.

An estimating method according to an eleventh aspect of the present disclosure includes: generating a multicarrier signal obtained by modulating a plurality of subcarrier signals; causing a transmission antenna to transmit the multicarrier signal, by processing and outputting the multicarrier signal to the transmission antenna, the transmission antenna including M transmission antenna elements, where M is a natural number greater than or equal to 1; measuring, for a first period equivalent to a cycle derived from an activity of a living body, a plurality of reception signals which are received by each of N reception antenna elements included in a reception antenna and which include a reflected signal which is the multicarrier signal transmitted from each of the M transmission antenna elements that has been reflected or dispersed by the living body, where N is a natural number greater than or equal to 1, where at least one of M or N is greater than or equal to 2; calculating, for each of a plurality of subcarriers to which the plurality of subcarrier signals correspond, a plurality of first complex transfer functions indicating a propagation characteristic between a transmission antenna element and a reception antenna element in each of M×N combinations which are combinations of each of the M transmission antenna elements and each of the N reception antenna elements, using the plurality of reception signals measured in the first period; and calculating a second complex transfer function by dividing all elements based on the plurality of first complex transfer functions by a direct wave component extracted using one or more elements based on the plurality of first complex transfer functions, the direct wave component having arrived not via the living body from the plurality of reception signals.

With this, a second complex transfer function can be calculated in which components corresponding to frequency phase error and at least one of the following are inhibited: (1) clock fluctuations between a transmission device including a transmission signal generator that transmits from a transmission antenna and a transmitter, and a reception device including a receiver that receives via a reception antenna, or (2) timing fluctuations in digital-to-analog conversion of the transmission signal or analog-to-digital conversion of the reception signal. Accordingly, information related to a living body can be obtained quickly and accurately by using radio signals.

With this configuration, a living body radar can be realized by repurposing an existing communication device by using a multicarrier signal such as an OFDM signal as a transmission signal. For example, OFDM reception devices are already widely used as mobile phones, television broadcast reception devices, wireless LAN devices, and so on, and are lower in cost than when non-modulated signals are used.

A program according to a twelfth aspect of the present disclosure is a program for causing a computer to execute the estimating method according to the eleventh aspect.

Note that the present disclosure can be realized not only as a device, but also as an integrated circuit including processing means included in such a device, as a method including steps corresponding to processing means included in the device, as a program that causes a computer to execute those steps, or as information, data, or a signal indicating the program. Those programs, information, data, and signals may be distributed via a recording medium such as CD-ROM or via a communication medium such as the Internet.

Hereinafter, exemplary embodiments of the present disclosure will be described in detail with reference to the Drawings. It should be noted that each of the exemplary embodiments described hereinafter illustrate a specific example of the present disclosure. The numerical values, shapes, materials, elements, the arrangement and connection of the elements, steps, the processing order of the steps, etc., shown in the following exemplary embodiments are mere examples, and are therefore not intended to limit the present disclosure. Furthermore, among elements in the following exemplary embodiments, those not recited in any one of the independent claims defining the most generic concept of the present disclosure are described as optional elements making up a more preferable form. It should be noted that in the Specification and the Drawings, elements having substantially the same functional configuration are given the same numerical sign in order to omit overlapping descriptions.

### Embodiment 1

Hereinafter, a method with which the distance to a living body that is a detection target is estimated by estimating device 100 according to the embodiment will be described with reference to the drawings.

### [Configuration of Estimating Device 100]

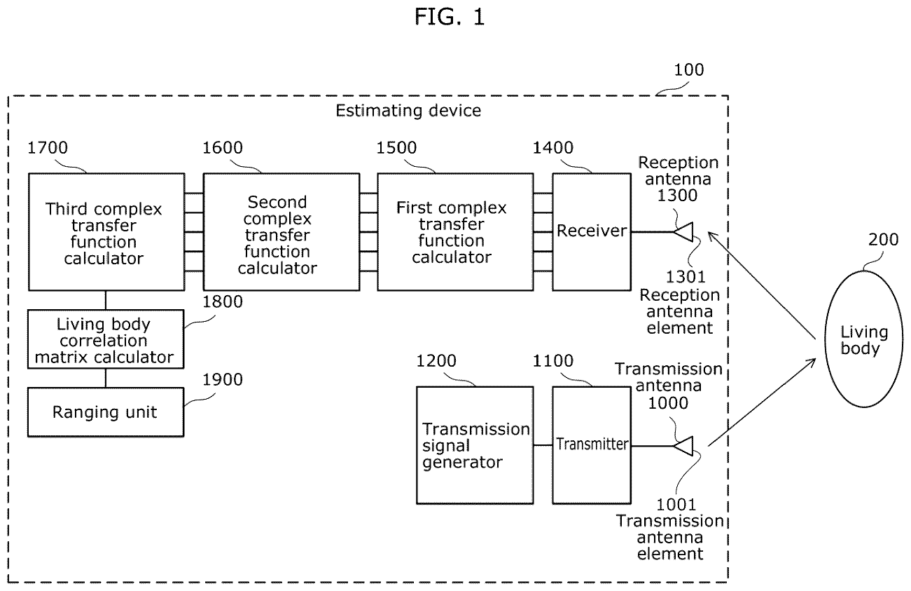

FIG. 1 is a block diagram illustrating an example of a configuration of estimating device 100 according to the embodiment.

Estimating device 100 illustrated in FIG. 1 includes transmission antenna 1000, transmitter 1100, transmission signal generator 1200, reception antenna 1300, receiver 1400, first complex transfer function calculator 1500, second complex transfer function calculator 1600, third complex transfer function calculator 1700, living body correlation matrix calculator 1800, and ranging unit 1900. Estimating device 100 estimates the position of living body 200 using the position of estimating device 100 as a reference. Estimating device 100 estimates, for example, the distance from estimating device 100 to living body 200.

### [Transmission Signal Generator 1200]

Transmission signal generator 1200 generates a multicarrier signal obtained by responding a plurality of subcarrier signals for each of the M transmission antenna elements included in transmission antenna 1000. Transmission signal generator 1200 generates S subcarrier signals corresponding to S subcarriers (where S is a natural number greater than or equal to 2) having mutually different frequency bands, and generates a multicarrier signal by multiplexing the generated S subcarrier signals. In the present embodiment, transmission signal generator 1200 is exemplified as an OFDM signal as a multicarrier signal. However, aside from generating an OFDM signal in which respective subcarriers are orthogonal, other multicarrier signals such as a simple frequency division multiplexing (FDM) signal may be generated as long as it is a multicarrier signal obtainable by multicarrier modulation. It should be noted that an OFDM signal has a high frequency band utilization efficiency, and is, for example, a signal in which S subcarrier signals corresponding to S subcarriers are multiplexed.

Furthermore, the signal generated by transmission signal generator 1200 may be a signal that is shared with a signal used for communication.

### [Transmitter 1100]

Transmitter 1100 adds appropriate processing to the signal generated by transmission signal generator 1200, to generate a transmission wave. The processing carried out here includes, for example, up-conversion in which the signal is converted from the intermediate frequency (IF) frequency band to the radio frequency (RF) frequency band, amplification in which the signal is amplified to the appropriate transmission level, etc. Then, as illustrated in FIG. 1, transmitter 1100 outputs the processed multicarrier signal to transmission antenna 1000 to thereby cause transmission antenna 1000 to transmit the multicarrier signal. With this, the multicarrier signal is transmitted from the M (M is a natural number greater than or equal to 1) transmission antenna elements 1001 included in transmission antenna 1000.

### [Transmission Antenna 1000]

Transmission antenna 1000 includes M transmission antenna elements 1001. In the present embodiment, transmission antenna 1000 includes one transmission antenna element 1001. As described above, transmission antenna element 1001 transmits a signal (transmission wave) generated by transmitter 1100.

### [Reception Antenna 1300]

Reception antenna 1300 includes N (N is a natural number of at least 1) reception antenna elements 1301. In the present embodiment, reception antenna 1300 includes one reception antenna element 1301. For example, as illustrated in FIG. 1, the one reception antenna element 1301 receives a signal that was transmitted by the one transmission antenna element 1001 and reflected by living body 200 (i.e., a reception signal).

### [Receiver 1400]

Receiver 1400 measures, for a first period equivalent to a cycle derived from an activity of living body 200, the reception signal that is received by reception antenna element 1301 and includes a reflected signal which is the multicarrier signal transmitted from transmission antenna element 1001 that has been reflected or dispersed by living body 200. A cycle derived from the activity of the living body is a living body-derived cycle (living body fluctuation cycle) which is a time period greater than or equal to a half-cycle of any of respiration, heartbeat, and body motion of living body 200.

Receiver 1400 converts the high-frequency signal received by reception antenna element 1301 into a low-frequency signal on which signal processing can be performed. Then, receiver 1400 demodulates the M OFDM signals transmitted by transmission antenna element 1001 into S×M subcarrier signals. In the present embodiment, since M=1, S subcarrier signals are demodulated. Each of the S×M subcarrier signals is represented by an IQ symbol. Receiver 1400 outputs, to first complex transfer function calculator 1500, the S×M sets of subcarrier signals (low-frequency signals) obtained by converting the high-frequency signal received by the N reception antenna elements 1301, for at least the first period.

It should be noted that, receiver 1400 may continue to measure the reception signals already received by reception antenna 1300, and continuously or periodically transmit the S×M subcarrier signals (IQ symbols) to first complex transfer function calculator 1500.

### [First Complex Transfer Function Calculator 1500]

First complex transfer function calculator 1500, using the reception signals measured in the first period by receiver 1400, calculates, for each of the subcarriers to which the subcarrier signals correspond, a plurality of first complex transfer functions indicating propagation characteristics between transmission antenna element 1001 and reception antenna element 1301 in each of M×N combinations which are the combinations of each of the M transmission antenna elements 1001 and each of the N reception antenna elements 1301. In the present embodiment, estimating device 100 includes one transmission antenna element 1001 and one reception antenna element 1301, so there is one combination.

In the present embodiment, first complex transfer function calculator 1500 calculates, as shown in Equation 1, using the S subcarrier signals (IQ symbols) transmitted from receiver 1400, a first complex transfer function vector h as a first complex transfer function indicating the propagation characteristic between transmission antenna element 1001 and reception antenna element 1301, for each of the S subcarrier signals.

$$\begin{matrix}[ Math . 1 ] & \\ h = [ {h}_{1} … , {h}_{S} ] & ( Equation 1 )\end{matrix}$$

### [Second Complex Transfer Function Calculator 1600]

Here, the first complex transfer function vector h includes frequency variation components derived from the transmission device and reception device, and Doppler shift derived from the living body. The first complex transfer function vector also includes reflected waves that did not arrive via living body 200, such as direct waves and reflected waves derived from a fixed object.

The frequency variation components derived from the transmission device and reception device include, for example, (i) attenuation or phase rotation due to spatial propagation of the transmission signal, (ii) clock frequency error (f_{RX}−f_{TX}) between the transmission device and reception device, (iii) sampling clock frequency errors used in the wireless device such as DA conversion. In order to remove the phase rotation of the frequency variation components derived from the transmission device and reception device from the first complex transfer function vector h, second complex transfer function calculator 1600 extracts any one element h_{I} of the first complex transfer function vector h as a direct wave component.

$$\begin{matrix}[ Math . 2 ] & \\ {h}^{′} = h / {h}_{l} & ( Equation 2 )\end{matrix}$$

Second complex transfer function calculator 1600 calculates the second complex transfer function vector h′ by dividing all elements of the first complex transfer function vector h by one element h_{I} extracted as a direct wave component, as shown in Equation 2. Here, the element of the direct wave component may be any element as long as it is one of the elements of the first complex transfer function vector h, such as element h₁. Note that the second complex transfer function vector h′ is one example of a second complex transfer function.

In this manner, second complex transfer function calculator 1600 performs a predetermined operation using one or more elements of the first complex transfer function vector h to calculate, from the first complex transfer function vector h, a second complex transfer function vector h′ in which components corresponding to at least one of the following are inhibited: (1) clock fluctuations between a transmission device including transmission signal generator 1200 that transmits from transmission antenna 1000 and transmitter 1100, and a reception device including receiver 1400 that receives via reception antenna 1300, or (2) timing fluctuations in digital-to-analog conversion of the transmission signal or analog-to-digital conversion of the reception signal. Specifically, second complex transfer function calculator 1600 calculates a second complex transfer function by dividing all elements of the first complex transfer function by a direct wave component extracted using one or more elements of the first complex transfer function. A direct wave component is a component that did not arrive via living body 200, extracted from a plurality of reception signals.

### [Third Complex Transfer Function Calculator 1700]

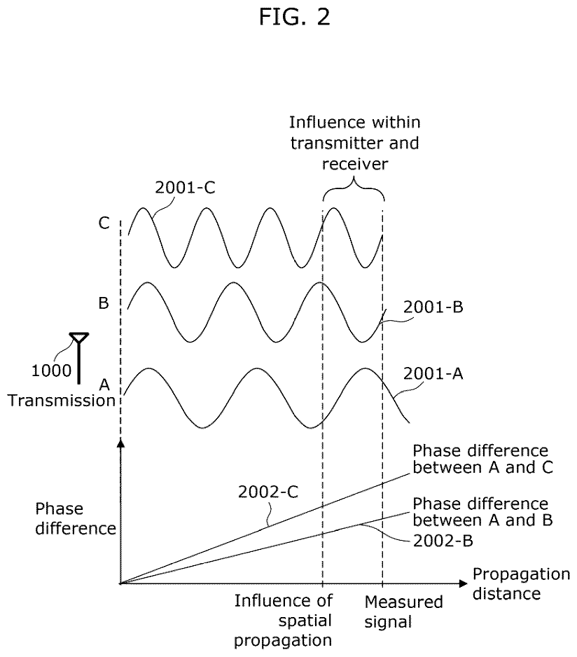

Third complex transfer function calculator 1700 obtains the second complex transfer function vector h′ calculated by second complex transfer function calculator 1600, and calculates the frequency phase correction value h_{cal1} for calibrating (correcting) the phase error in the frequency direction. The phase error in the frequency direction is a phase error between a plurality of signals having mutually different frequencies. Phase errors that require calibration will be described with reference to FIG. 2. FIG. 2 is a schematic diagram illustrating that the phase of a reception signal changes due to frequency and distance.

When signals of different frequencies propagate through a space and are received, the amount of phase rotation by a transmission signal with respect to the reception signal is different depending on the frequency and the distance between the transmission antenna and the reception antenna (hereafter referred to as inter-antenna distance). FIG. 2 illustrates three transmission waves 2001-A, 2001-B, and 2001-C, which are signals with mutually different frequencies transmitted from transmission antenna 1000 with the same phase, and it can be seen that the phases continue to differ as the propagation distance increases (2002-B, 2002-C). For this reason, the inter-antenna distance can be calculated by transmitting and receiving signals having a plurality of already-known frequencies, measuring phase differences, and performing back calculation. However, the phase difference that is actually measured includes, not only the influence of spatial propagation between the transmission antenna and the reception antenna, but also error due to the influence of phase characteristics of internal circuits of the transmission device and reception device, antennas (hereinafter such an error is referred to as a phase error). For this reason, in order to correctly measure the inter-antenna distance, it is necessary to remove the phase error from the measured signal.

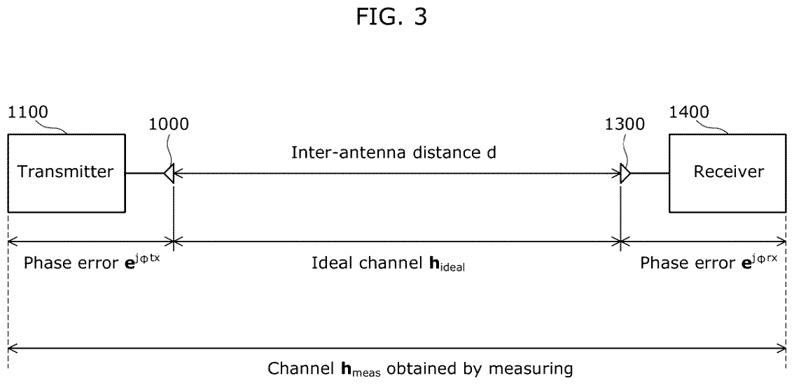

FIG. 3 is a diagram illustrating the correspondence between the previously described phase error and a channel (complex transfer function).

The phase error can be calculated by calculating the difference between channel hₘₑₐₛ indicated by a matrix obtained by measurement and an ideal channel h_{ideal} of the space indicated by a matrix that can be calculated from the inter-antenna distance. This is not limited to estimating the inter-antenna distance but also applies to the case of estimating the distance to living body 200.

Hereinafter, the specific operation of third complex transfer function calculator 1700 will be described. Third complex transfer function calculator 1700 obtains the second complex transfer function vector h′, and corrects the phase error in the frequency direction. Here, a frequency phase error refers to, among differences with respect to the phase of reference subcarrier signal S0 in the second complex transfer function matrix, a phase difference not resulting from spatial propagation between the antennas. More specifically, the frequency phase error includes errors due to the influence of the frequency characteristics of transmitter 1100 and receiver 1400, the electrical length of the internal circuitry of transmitter 1100, the electrical length of the internal circuitry of receiver 1400, and so on. The phase error includes phase error e^{jφtx} caused by transmission antenna 1000 and transmitter 1100 and phase error e^{jφrx} caused by reception antenna 1300 and receiver 1400.

Third complex transfer function calculator 1700 calculates the frequency phase correction value for each element of the second complex transfer function vector using a predetermined method. First, third complex transfer function calculator 1700 calculates h_{ideal}, which is the ideal channel between antenna elements, based on distance d between transmission antenna element 1001 and reception antenna element 1301 that is inputted in advance. Here, h_{ideal} is a vector represented by the complex number, and has S elements which is the subcarrier number. The i-th element is calculated by Equation 3.

$$\begin{matrix}[ Math . 3 ] & \\ {h}_{ideal ( i )} = exp ( - {jk}_{i} d ) & ( Equation 3 )\end{matrix}$$

Here, kᵢ is the i-th subcarrier wavenumber.

In this manner, h_{ideal1} is an ideal complex transfer function between the transmission antenna element and the reception antenna element obtainable based on the inter-antenna distance between transmission antenna element 1001 and reception antenna element 1301.

Next, third complex transfer function calculator 1700 obtains, from second complex transfer function calculator 1600, a reference complex transfer function vector that is a complex transfer function vector received during the second period, and serves as a reference. The second period is equivalent to a cycle derived from an activity of living body 200. A cycle derived from the activity of the living body is a living body-derived cycle (living body fluctuation cycle) which is a time period greater than or equal to a half-cycle of any of the cycles of respiration, heartbeat, and body motion of living body 200. It should be noted that measurement of the reference complex transfer function vector is preferably performed in a person-free state in which there is little influence from moving objects such as living bodies, but may include the influence of living bodies and other moving objects. An initial complex transfer function vector obtained from second complex transfer function calculator 1600 may be used for the reference complex transfer function vector. It should be noted that, when the second period is not in a person-free state or when the direct wave component is not sufficiently big, the reference complex transfer function vector may be a complex transfer function vector obtained by performing Fourier transform on the measured complex transfer function vector for the measurement time (slow time) and extracting only a component that does not temporally fluctuate. Third complex transfer function calculator 1700 may calculate a new reference complex transfer function matrix based on data of a timing at which fluctuation obtained by simultaneously calculating the temporal fluctuations of absolute values of complex transfer functions is small, and update the reference complex transfer function matrix with the new reference complex transfer function matrix calculated. In the present embodiment, since there is one transmission antenna element 1001 and one reception antenna element 1301, the reference complex transfer function vector is a vector having an element number of S.

Next, third complex transfer function calculator 1700 calculates the frequency phase correction value h_{cal1} for correcting the frequency phase errors in S subcarriers, based on the ideal channel h_{ideal1} and the reference complex transfer function (channel hₘₑₐₛ). More specifically, third complex transfer function calculator 1700 calculates the ratio between h_{ideal1}, which is the ideal channel obtained by calculation, and the measured reference complex transfer function matrix hₘₑₐₛ, and sets the ratio as the frequency phase correction value h_{cal1}. Specifically, the frequency phase correction value h_{cal1} is calculated using the following Equation 4.

$$\begin{matrix}[ Math . 4 ] & \\ {h}_{cal} = {h}_{ideal} \text{?} {h}^{′} & ( Equation 4 )\end{matrix}$$

Here, Ø represents Hadamard division, which is element-wise division of vectors.

The frequency phase correction value h_{cal} is the same as long as the reference complex transfer function does not change. For this reason, third complex transfer function calculator 1700 may store the calculated frequency phase correction value h_{cal1} in a memory or the like, and use the frequency phase correction value h_{cal1} stored in the memory or the like from the next time onward. Stated differently, once third complex transfer function calculator 1700 calculates the frequency phase correction value h_{cal1}, it does not need to calculate the frequency phase correction value h_{cal1} from the next time onward.

Finally, third complex transfer function calculator 1700 corrects the second complex transfer function vector h′ according to the following Equation 5, based on the frequency phase correction value h_{cal}, and calculates a third complex transfer function vector h″. Third complex transfer function vector h″ is one example of a third complex transfer function.

$$\begin{matrix}[ Math . 5 ] & \\ {h}^{″} = {e}^{{j ∠ h}_{cal}} ∘ {h}^{′} & ( Equation 5 )\end{matrix}$$

Here, ∠h_{cal} represents the phase angle of h_{cal}, and ∘ represents the Hadamard product, which is the element-wise multiplication.

In this manner, third complex transfer function calculator 1700 calculates a third complex transfer function vector h″ in which frequency phase errors in a plurality of subcarriers are corrected, based on the distance between transmission antenna element 1001 and reception antenna element 1301 and the reference complex transfer function matrix which is the complex transfer function measured for the second period.

Third complex transfer function calculator 1700 outputs the calibrated third complex transfer function vector h″ obtained in the above-described manner to living body correlation matrix calculator 1800 located downstream.

It should be noted that, in the present embodiment, although a method of calculating the calibration value from the measurement result of a complex transfer function is described, in cases where the calibration value does not change over time, a value measured at the factory, or the like, using a measuring device such as a network analyzer, or the like, may be stored in memory as the calibration value, and this calibration value may be used for calculating the third complex transfer function vector h″.

### [Living Body Correlation Matrix Calculator 1800]

For each of the S subcarriers and each of the M×N combinations, living body correlation matrix calculator 1800 successively records, in the time-series order in which they are measured, the calculated third complex transfer function vector h″. Living body correlation matrix calculator 1800 extracts, for each of the S subcarriers and each of the M×N combinations, components of the living body from the third complex transfer function vector h″ recorded in time series and measured for the first period, to thereby calculate, for each of the S subcarriers, a living body component transfer function vector expressed by a M×N-dimension matrix.

Here, the living body component transfer function vector is the extracted reflected wave or dispersed wave (living body component) included in the reception signal that passed via living body 200. The methods of calculating the living body component from the complex transfer functions recorded in time-series include the method using Fourier transform disclosed in PTL 1, and the method using difference information disclosed in PTL 2.

For example, with the method that uses Fourier transform, by performing Fourier transform on third complex transfer function vector h″ for the measurement time (slow time) and extracting only specific frequency components, living body component transfer function vector h″_{fft} can be calculated. Here, living body component transfer function vector het is calculated for each of frequency components included in the frequencies, for example, 0.1 Hz to 3 Hz, which can include the influence of activities of the living body. In this method, by further performing inverse Fourier transform in the subcarrier direction on the calculated living body component transfer function vector h_{fft} and calculating the living body component transfer function vector h_{ifft} expressed in the time domain, the time from when a signal including a living body component is transmitted from transmitter 1100 to when it is received by receiver 1400 is calculated.

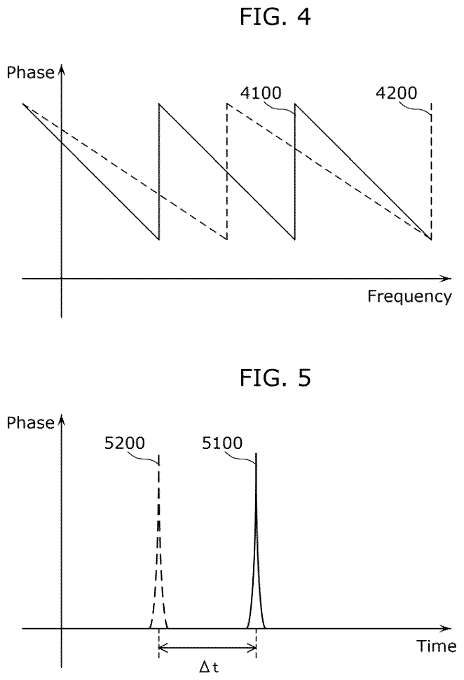

Here, the relationship between frequency (column direction of the matrix) and phase of living body component transfer function vector h″_{fft} is illustrated in FIG. 4. Solid line 4100 represents the fluctuation of the phase of each component of the living body component transfer function vector according to the subcarrier frequency when living body 200 is present at a certain position. The phase here is the difference from the phase in channel h_{I} (frequency of subcarrier S0) serving as a reference during second complex transfer function calculation. Since the length of the path of the radio wave reflected by living body 200 becomes shorter when living body 200 approaches transmission antenna element 1001 or reception antenna element 1301 from the aforementioned position, the slope on the graph becomes gentle and becomes like broken line 4200. In principle, time of flight (ToF) or the distance to the living body can be estimated from this graph slope. Specifically, when time domain living body component transfer function vector h″_{ifft} is calculated by further performing inverse Fourier transform in the subcarrier direction on living body component transfer function vector h″_{fft}, the time from when a signal including a living body component is transmitted from the transmission device to when the signal is received by the reception device is obtained.

FIG. 5 illustrates the relationship between the time (column direction of the matrix) and the phase of time domain living body component transfer function vector h″_{ifft}. The phase changes of solid line 4100 and broken line 4200 in FIG. 4 appear as the peaks shown by solid line 5100 and broken line 5200, respectively. However, temporal resolution Δt of time that is calculated here is expressed by Equation 6 using the subcarrier bandwidth B.

$$\begin{matrix}[ Math . 6 ] & \\ Δ t = \frac{1}{B} [ s ] & ( Equation 6 )\end{matrix}$$

For example, when the bandwidth is 20 MHz, the temporal resolution is equivalent to 0.05 μs or approximately 15 m when converted to distance resolution, which does not stand up to practical use.

In view of this, in the present embodiment, resolution is improved by using the multiple signal classification (MUSIC) method. In order to use the MUSIC method, living body correlation matrix calculator 1800 calculates correlation matrix Rf (living body correlation matrix) of living body component transfer function vector h″_{fft} according to the following Equation 7.

$$\begin{matrix}[ Math . 7 ] & \\ {R}_{f} = E [ {h}_{fft}^{″} {h}_{fft}^{″H} ] & ( Equation 7 )\end{matrix}$$

Here, living body component transfer function vector h″_{fft} is present for each frequency that may include vibration caused by the living body after the Fourier transform on the third complex transfer function vector h″. E[•] in Equation 7 denotes the average processing in the frequency direction.

### [Ranging Unit 1900]

Ranging unit 1900 performs ranging according to the MUSIC method, using correlation matrix Rf calculated by living body correlation matrix calculator 1800. First, ranging unit 1900 performs Eigendecomposition of correlation matrix Rf, and calculates vector Us corresponding to a signal and eigenvector UN corresponding to noise. Here, eigenvectors corresponding to a signal are the vectors counted in order from a first eigenvector to the number of targets to be ranged, and is, for example, only the first eigenvector when the target is one person. Furthermore, when the targets are k persons (k being a natural number greater than or equal to 2), the eigenvectors corresponding to a signal are the k eigenvectors from the first eigenvector to the k-th eigenvector. In addition, eigenvectors corresponding to noise refers to eigenvectors other than the eigenvectors corresponding to a signal.

Music spectrum P_{MUSIC}(d) is calculated according to the following equation, using eigenvectors obtained in the above-described manner.

$$\begin{matrix}[ Math . 8 ] & \\ {P}_{MUSIC} ( d ) = \frac{{a}^{H} ( d ) a ( d )}{{a}^{H} ( d ) {U}_{N} {U}_{N}^{H} a ( d )} & ( Equation 8 )\end{matrix}$$

Here, a(d) represents a steering vector, and is calculated as shown in Equation 9.

$$\begin{matrix}[ Math . 9 ] & \\ a ( d ) = {[ {e}^{- j \frac{2 π}{{λ}_{1}} d} , … , {e}^{- j \frac{2 π}{{λ}_{i}} d} , … , {e}^{- j \frac{2 π}{{λ}_{S}} d} ]}^{T} & ( Equation 9 )\end{matrix}$$

Here, λᵢ represents the wavelength of the i-th subcarrier.

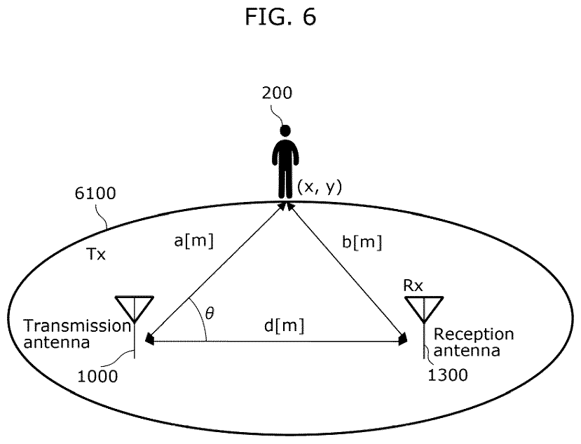

d, which takes the maximum value of MUSIC spectrum P_{MUSIC}(d) obtained in the above manner, corresponds to the sum (third distance) of distance a (first distance) and distance b (second distance) in FIG. 6 described later. Distance a (first distance) is the distance between transmission antenna element 1001 and living body 200. Distance b (second distance) is the distance between reception antenna element 1301 and living body 200. In other words, ranging unit 1900 can calculate the third distance by calculating maximum value d. In this manner, ranging unit 1900 estimates the third distance that is the sum of the first distance between transmission antenna 1000 and living body 200 and the second distance, by using the living body correlation matrix calculated for each of the plurality of subcarriers.

FIG. 6 is a schematic diagram illustrating the position of a living body which is limited by the relationship between the living body, a transmission antenna element, and a reception antenna element, and by a third distance.

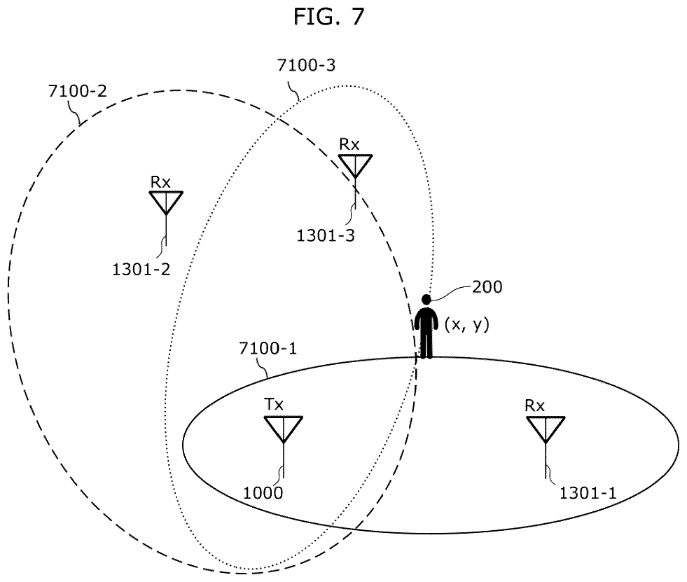

As illustrated in FIG. 6, by estimating the third distance, it can be seen that the position of living body 200 in a plane is limited to the circumference of ellipse 6100 which has the positions of transmission antenna 1000 and reception antenna 1300 as foci. It should be noted that, as illustrated in FIG. 7, the position of living body 200 may be estimated from the intersection points of ellipses by using three or more transmission antennas 1000 or reception antennas 1300 and estimating a plurality of third distances.

FIG. 7 is a schematic diagram illustrating the estimation of the position of a living body by using a plurality of reception antenna elements.

Reception antenna 1300 of estimating device 100 in this case includes three reception antenna elements 1301-1, 1301-2, and 1301-3. It should be noted that it is sufficient that reception antenna 1300 includes three or more reception antenna elements, and is not limited to having three reception antenna elements. Moreover, instead of reception antenna 1300 including three or more reception antenna elements, transmission antenna 1000 may include three or more transmission antenna elements.

Accordingly, for each of the three combinations (that is, the M×N combinations) including the combination of transmission antenna element 1001 and reception antenna element 1301-1, the combination of transmission antenna element 1001 and reception antenna element 1301-2, and the combination of transmission antenna element 1001 and reception antenna element 1301-3, ellipses 7100-1, 7100-2, 7100-3 which have the positions of the transmission antenna element and reception antenna element included in the combination as foci and the length of their major axis as a third distance are calculated, and the position of living body 200 is estimated based on the three (that is, M×N) intersection points that are closest to each other among the intersection points between the three (that is, M×N) ellipses 7100-1, 7100-2, 7100-3 obtained from the calculation.

### [Other Examples of Direct Wave Component]

It should be noted that, although second complex transfer function calculator 1600 of the embodiment calculated the second complex transfer function vector h′ by dividing the first complex transfer function vector h by any one element h_{I} within the first complex transfer function vector h as a direct wave component, the present disclosure is not limited to dividing by one element h_{I}.

More specifically, for extraction of the direct wave component, two or more elements respectively corresponding to two or more subcarriers that are adjacent in frequency among the plurality of subcarriers may be used from among the plurality of elements included in the first complex transfer function vector. The two or more elements are elements corresponding to two or more subcarriers that are all adjacent to each other among the plurality of subcarriers having mutually different frequencies. The two or more subcarriers include at least two first subcarriers, each of which is adjacent to only one other subcarrier. The subcarriers other than the two first subcarriers among the two or more subcarriers are each adjacent to two other subcarriers. In this manner, two or more subcarriers that are adjacent to each other include a plurality of subcarriers that are continuously adjacent from the subcarrier corresponding to the lowest frequency to the subcarrier corresponding to the highest frequency, among the two subcarriers. Hereinafter, the two or more subcarriers that are adjacent to each other may be referred to as K subcarriers (K=K₁+K₂, where K₁ is a non-negative integer satisfying I−K₁≥1, and K₂ is a non-negative integer satisfying I+K₂≤S) adjacent in the subcarrier direction.

For example, the direct wave component used for division of the I-th element h_{I} of the first complex transfer function vector h may be an average value of the I-th element h_{I} of the first complex transfer function vector h and K elements adjacent in the subcarrier direction. The average value h_{Imean} of the I-th element is calculated using the following Equation 10, and the I-th element h_{I}′ of the second complex transfer function vector h′ is calculated using the calculated average value h_{Imean} of the I-th element and Equation 11.

$$\begin{matrix}[ Math . 10 ] & \\ {h}_{lmean} = \frac{1}{K + 1} {\sum }_{k = l - {K}_{1}}^{l + {K}_{2}} {h}_{k} & ( Equation 10 )\end{matrix}$$

$$\begin{matrix}[ Math . 11 ] & \\ {h}_{l}^{′} = {h}_{l} / {h}_{lmean} & ( Equation 11 )\end{matrix}$$

In such cases, the second complex transfer function vector h′ is calculated using Equation 11 based on each element of the first complex transfer function vector h. Here, the number of elements of the second complex transfer function vector h′ that can be calculated from Equation 10 is S−K. In such cases, the steering vector a(d) used in Equation 8 is calculated as shown in Equation 12.

$$\begin{matrix}[ Math . 12 ] & \\ a ( d ) = {[ {e}^{- j \frac{2 π}{{λ}_{{K}_{1}}} d} , {e}^{- j \frac{2 π}{{λ}_{( {K}_{1} + 1 )}} d} , … , {e}^{- j \frac{2 π}{{λ}_{( S - {K}_{2} )}} d} ]}^{T} & ( Equation 12 )\end{matrix}$$

For example, the direct wave component used for division may be calculated based on eigenvalues and eigenvectors calculated from Equations 13 and 14 by obtaining h(t) by measuring the complex transfer function for a certain period, and performing Eigendecomposition of the correlation matrix for the entire measurement time. In this way, the second complex transfer function vector h′ may be calculated as shown in Equation 15.

$$\begin{matrix}[ Math . 13 ] & \\ {R}_{R} = {UD}_{R} {U}^{H} & ( Equation 13 )\end{matrix}$$

$$\begin{matrix}[ Math . 14 ] & \\ {R}_{T} = {VD}_{T} {V}^{H} & ( Equation 14 )\end{matrix}$$

$$\begin{matrix}[ Math . 15 ] & \\ {h}^{′} ( t ) = h ( t ) / ( {u}_{1}^{H} h ( t ) {v}_{1} ) & ( Equation 15 )\end{matrix}$$

As shown in Equations 13 and 14, second complex transfer function calculator 1600 calculates correlation matrices R_{R} and R_{T} of the first complex transfer function vector h(t), and calculates eigenvalues D_{R}, D_{T} and eigenvectors U, V by performing Eigendecomposition of the calculated correlation matrices R_{R} and R_{T}. Next, second complex transfer function calculator 1600 uses the results calculated from Equations 13 and 14, as shown in Equation 15, to multiply eigenvectors u₁ and v₁, which are the pair corresponding to the maximum eigenvalues D_{R} and D_{T}, by the first complex transfer function vector h(t) to calculate the direct wave channel component u₁^{H}h(t)v₁, and calculates the second complex transfer function vector h′ by dividing all elements of the first complex transfer function vector h by the direct wave channel component u₁^{H}h(t)v₁.

It should be noted that the direct wave component may be calculated based on eigenvectors calculated from Equations 13 and 14 by performing Eigendecomposition of the correlation matrix for the entire measurement time. In this way, the second complex transfer function vector h′ may be calculated as shown in Equation 16.

$$\begin{matrix}[ Math . 16 ] & \\ {h}^{′} ( t ) = h ( t ) / ( \frac{{u}_{1}^{H} h ( t ) {v}_{1}}{{u}_{1}^{H} h ( {t}_{1} ) {v}_{1}} ) & ( Equation 16 )\end{matrix}$$

### [Other Examples of Living Body Correlation Matrix]

It should be noted that, although living body correlation matrix calculator 1800 of the embodiment calculated correlation matrix Rf by a method using Fourier transform, the living body correlation matrix may be calculated using a lower triangular matrix.

Living body correlation matrix calculator 1800 may calculate correlation matrix R of the second complex transfer function vector h′ as shown in Equation 17.

$$\begin{matrix}[ Math . 17 ] & \\ R = {h}^{′} {{h}^{′}}^{H} = ( \begin{matrix}{h}_{1}^{′} {h}_{1}^{′ H} & … & {h}_{1}^{′} {h}_{S}^{′ H} \\ ⋮ & ⋱ & ⋮ \\ {h}_{S}^{′} {h}_{1}^{′ H} & … & {h}_{S}^{′} {h}_{S}^{′ H}\end{matrix} ) & ( Equation 17 )\end{matrix}$$

Living body correlation matrix calculator 1800 calculates a lower triangular vector h″ by vectorizing the lower triangular matrix excluding the diagonal terms of correlation matrix R as shown in Equation 18.

$$\begin{matrix}[ Math . 18 ] & \\ {h}^{″} = {[ {h}_{2}^{′} {h}_{1}^{′ H} , … {h}_{S}^{′} {h}_{S}^{′ H} , … , {h}_{S}^{′} {h}_{( S - 1 )}^{′ H} ]}^{T} & ( Equation 18 )\end{matrix}$$

Living body correlation matrix calculator 1800 can calculate a living body component transfer function vector h″_{fft} for each of frequency components from 0.1 Hz to approximately 3 Hz by performing Fourier transform on the lower triangular vector h″ for the measurement time (slow time) and extracting only specific frequency components. Living body correlation matrix calculator 1800 calculates correlation matrix Rf from living body component transfer function vector h″_{fft} according to Equation 7.

In such cases, the steering vector a(d) in Equation 8 is calculated as follows.

$$\begin{matrix}[ Math . 19 ] & \\ {a ( d )}^{′} = {[ {e}^{- j \frac{2 π}{{λ}_{1}} d} , … , {e}^{- j \frac{2 π}{{λ}_{i}} d} , … , {e}^{- j \frac{2 π}{{λ}_{s}} d} ]}^{T} & ( Equation 19 )\end{matrix}$$

$$\begin{matrix}[ Math . 20 ] & \\ {R}_{a} ( d ) = {a ( d )}^{′} {a ( d )}^{′ H} = ( \begin{matrix}{{a}_{1} ( d )}^{′} {{a}_{1} ( d )}^{′ H} & … & {{a}_{1} ( d )}^{′} {{a}_{S} ( d )}^{′ H} \\ ⋮ & ⋱ & ⋮ \\ {{a}_{S} ( d )}^{′} {{a}_{1} ( d )}^{′ H} & … & {{a}_{S} ( d )}^{′} {{a}_{S} ( d )}^{′ H}\end{matrix} ) & ( Equation 20 )\end{matrix}$$

Living body correlation matrix calculator 1800 calculates steering vector a(d) by vectorizing the lower triangular matrix excluding the diagonal terms of correlation matrix Rₐ(d) as shown in Equation 21.

$$\begin{matrix}[ Math . 21 ] & \\ a ( d ) = {[ {{a}_{2} ( d )}^{′} {{a}_{1} ( d )}^{′ H} , … {{a}_{S} ( d )}^{′} {{a}_{1} ( d )}^{′ H} , … , {{a}_{S} ( d )}^{′} {{a}_{S - 1} ( d )}^{′ H} ]}^{T} & ( Equation 21 )\end{matrix}$$

Living body correlation matrix calculator 1800 calculates Equation 18 and Equation 21 corresponding to the number of elements when using Equation 11 and Equation 12.

### [Operation of Estimating Device 100]

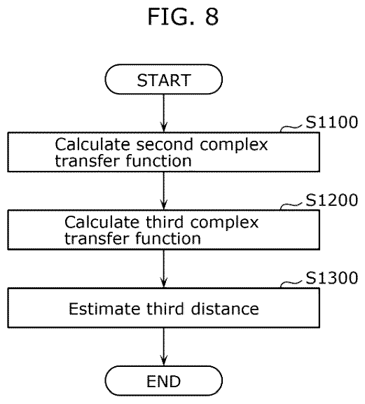

The operation in the estimation process by estimating device 100 configured in the above-described manner will be described. FIG. 8 is a flowchart illustrating the estimation process by estimating device 100 according to the present embodiment.

First, estimating device 100 calculates a second complex transfer function by dividing the first complex transfer function by the direct wave component (S1100).

Next, estimating device 100 calculates a third complex transfer function based on the calculated frequency phase correction value (S1200).

Estimating device 100 calculates living body correlation matrix based on the third complex transfer function, and estimates the third distance, which is the sum of distance a (the first distance) between transmission antenna 1000 and living body 200, and distance b (the second distance) between reception antenna 1300 and living body 200 (S1300).

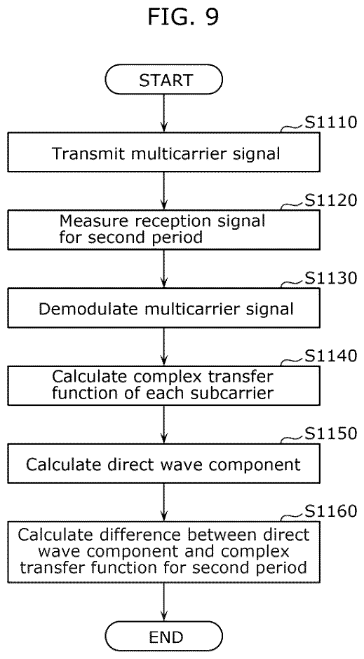

FIG. 9 is a flowchart illustrating the detailed processing in the second complex transfer function calculation in step S1100. First, estimating device 100 transmits a multicarrier signal including S subcarriers from transmission antenna element 1001 (S1110).

Then, for a second period in which a living body and other moving bodies are not present in a predetermined space which is the estimation target area, estimating device 100 measures a signal (reception signal) transmitted from transmission antenna element 1001 using reception antenna element 1301 (S1120).

Next, estimating device 100 performs multicarrier demodulation on the reception signals measured in the second period to demodulate the reception signals into S subcarrier signals (S1130).

Next, estimating device 100 calculates, from S subcarrier signals measured in the second period, a plurality of first complex transfer functions indicating the propagation characteristics between transmission antenna element 1001 and reception antenna element 1301, for each of the plurality of subcarriers to which the plurality of subcarrier signals respectively correspond (S1140). These processes are performed in parallel or sequentially for the respective subcarriers. Since the details are as described above, description will be omitted here. The same applies to the following steps.

Next, estimating device 100 calculates direct wave component h_{I} from the complex transfer function for each subcarrier (S1150).

Then, estimating device 100 calculates difference h′ between direct wave component h_{I} and the complex transfer function for the second period (S1160).

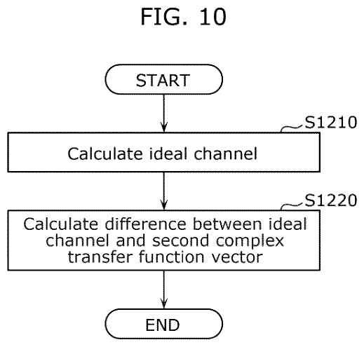

FIG. 10 is a flowchart illustrating the detailed processing in the third complex transfer function calculation in step S1200.

First, estimating device 100 calculates ideal channel h_{ideal} from the distance between transmission antenna element 1001 and reception antenna element 1301 provided in advance (S1210).

Then, estimating device 100 calculates frequency phase correction value h_{cal} from ideal channel h_{ideal} and second complex transfer function vector h′ (S1220).

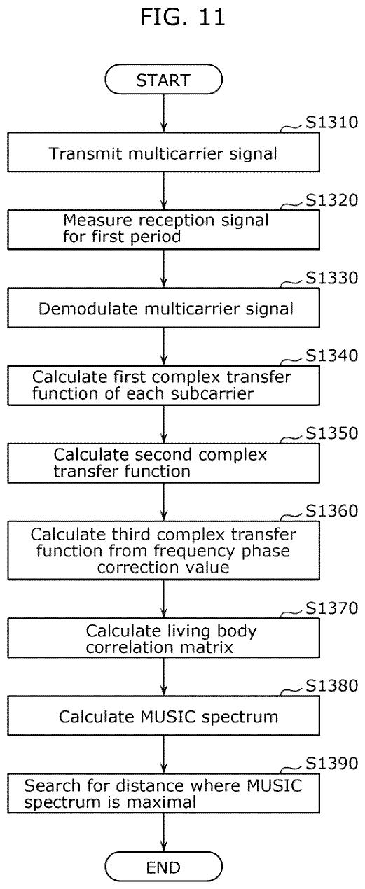

FIG. 11 is a flowchart illustrating the detailed processing in the ranging in step S1300.

First, estimating device 100 transmits a multicarrier signal including S subcarriers from transmission antenna element 1001 (S1310).

Then, estimating device 100 measures, for a first period equivalent to a cycle derived from an activity of living body 200, the reception signal that includes a reflected signal reflected by living body 200 (S1320).

Next, estimating device 100 performs multicarrier demodulation on the reception signals measured in the first period to demodulate the reception signals into S signal columns (S1330).

Next, estimating device 100 calculates, from the S subcarrier signals measured in the first period, a plurality of first complex transfer functions indicating the propagation characteristics between transmission antenna element 1001 and reception antenna element 1301, for each of the subcarriers to which the plurality of subcarrier signals respectively correspond (S1340).

Next, estimating device 100 calculates second complex transfer function vector h′ according to Equation 2 (S1350).

Next, estimating device 100 calculates third complex transfer function vector h″ by correcting the second complex transfer function vector h′ according to Equation 5 using the frequency phase correction value h_{cal} (S1360).

Next, estimating device 100 calculates living body component transfer function vector h″_{fft} from the calibrated third complex transfer function vector h″, and calculates correlation matrix Rf according to Equation 5 (S1370).

Next, estimating device 100 calculates Music spectrum P_{MUSIC}(d) according to Equation 8 (S1380).

Lastly, estimating device 100 searches for d which takes the maximum value of MUSIC spectrum P_{MUSIC}(d), and outputs the search result as the sum of distance a between transmission antenna element 1001 and living body 200, and distance b between living body 200 and reception antenna element 1301 (S1390).

### Advantageous Effects, Etc.

According to estimating device 100 and the estimating method according to the present embodiment, by using a multicarrier signal such as OFDM for the transmission signal, an existing multicarrier transceiver can be repurposed to be able to estimate the distance between a living body and an antenna.

Furthermore, using the MUSIC method enables ranging with fine distance resolution.

With estimating device 100 according to the present embodiment, the position of the living body can be estimated from the intersection points of ellipses by estimating a plurality of third distances to the reception device using three or more transmission devices.

With estimating device 100 according to the present embodiment, the position of the living body can be estimated from the intersection points of ellipses by estimating a plurality of third distances to the transmission device using three or more reception devices.

With estimating device 100 according to the present embodiment, the distance between the living body and antenna and the position of the living body can be estimated even with multiple input single output (MISO), single input multiple output (SIMO), or multiple input multiple output (MIMO) configurations.

As described above, estimating device 100 according to the present embodiment can realize an estimating device and an estimating method that are capable of quickly and accurately estimating the distance or position of a living body by using radio signals.

Although a positioning sensor and an estimating method according to an aspect of the present disclosure has been described above based on exemplary embodiments, the present disclosure is not limited to these exemplary embodiments. Various modifications to the exemplary embodiments that can be conceived by a person of ordinary skill in the art or forms obtained by combining elements of different embodiments, for as long as they do not depart from the essence of the present disclosure, are included in the scope of the present disclosure.

For example, although estimation of the distance or position of living body 200 is described as an example in the above embodiment, the present disclosure is not limited to living body 200. The present disclosure can be applied to various moving bodies (machines, etc.) whose activity imparts a Doppler effect on reflected waves in the case where a high-frequency signal is emitted.

For example, although the above embodiment mainly describes an example where the number of transmission antenna elements M is one and the number of reception antenna elements N is one, the present disclosure is not limited to this. The M transmission antenna elements may be two or more, and the N reception antenna elements may be two or more.

For example, although the above embodiment describes that estimating device 100 includes third complex transfer function calculator 1700, living body correlation matrix calculator 1800, and ranging unit 1900, estimating device 100 need not include these elements. Estimating device 100 may estimate information related to living body 200 using the second complex transfer function vector h′ calculated by second complex transfer function calculator 1600. Information related to living body 200 is, as described above, for example, the distance from the estimating device to the living body, the direction from the estimating device to the living body, the position of the living body, an identifier of the living body, and so on. In this manner, the second complex transfer function vector h′ calculated by estimating device 100 can be used not only to estimate the distance from the estimating device to the living body, but also to estimate the direction from the estimating device to the living body, the position of the living body, an identifier of the living body, and so on. Second complex transfer function vector h′ has inhibited components that correspond to frequency phase error and at least one of the following: (1) clock fluctuations between a transmission device including transmission signal generator 1200 that transmits from transmission antenna 1000 and transmitter 1100, and a reception device including receiver 1400 that receives via reception antenna 1300, or (2) timing fluctuations in digital-to-analog conversion of the transmission signal or analog-to-digital conversion of the reception signal. Accordingly, the direction from the estimating device to the living body, the position of the living body, an identifier of the living body, and so on can be accurately estimated.

In the above embodiments, each element may be configured using dedicated hardware, or may be implemented by executing a software program suitable for the element. Each element may be implemented by a program execution unit such as a CPU or processor reading and executing a software program recorded on a recording medium such as a hard disk or semiconductor memory.

The present disclosure can not only be realized as a positioning sensor including such characteristic elements, but can also be realized as an estimating method with steps corresponding to the characteristic elements included in the positioning sensor. The present disclosure can also be realized as a computer program that causes a computer to execute each of the characteristic steps included in such a method. It goes without saying that such a computer program can be distributed via a non-transitory computer-readable recording medium such as CD-ROM or via a communication network such as the Internet.

### INDUSTRIAL APPLICABILITY

The present disclosure can be used for positioning sensors and distance estimating methods that estimate the distance or position of a living body by using radio signals, and particularly, can be used for measuring instruments that measure the distance or position of a living body and a living body including a machine, home appliances that perform control according to the distance or position of a living body, surveillance devices that detect intrusion of a living body, and so on.

### REFERENCE SIGNS LIST

100 estimating device
200 living body
1000 transmission antenna
1001 transmission antenna element
1100 transmitter
1200 transmission signal generator
1300, 1300-1, 1300-2, 1300-3 reception antenna
1301 reception antenna element
1400 receiver
1500 first complex transfer function calculator
1600 second complex transfer function calculator
1700 third complex transfer function calculator
1800 living body correlation matrix calculator
1900 ranging unit
2001-A, 2001-B, 2001-C phase of each subcarrier signal transmitted from transmission antenna
2002-B, 2002-C phase change of signals with different frequencies transmitted from transmission antenna
4100, 4200 phase change of complex transfer function matrix with respect to frequency
5100, 5200 phase of complex transfer function matrix after inverse Fourier transform
6100, 7100-1, 7100-2, 7100-3 ellipse where living body may be present, determined by third distance

1. An estimating device comprising:
a transmission signal generator that generates a multicarrier signal obtained by modulating a plurality of subcarrier signals;
a transmission antenna including M transmission antenna elements, where M is a natural number greater than or equal to 1;
a transmitter that causes the transmission antenna to transmit the multicarrier signal, by processing and outputting the multicarrier signal to the transmission antenna;
a reception antenna including N reception antenna elements, where N is a natural number greater than or equal to 1;
a receiver that measures, for a first period equivalent to a cycle derived from an activity of a living body, a plurality of reception signals which are received by each of the N reception antenna elements and include a reflected signal which is the multicarrier signal transmitted from each of the M transmission antenna elements that has been reflected or dispersed by the living body;
a first complex transfer function calculator that calculates, for each of a plurality of subcarriers to which the plurality of subcarrier signals correspond, a plurality of first complex transfer functions indicating a propagation characteristic between a transmission antenna element and a reception antenna element in each of M×N combinations which are combinations of each of the M transmission antenna elements and each of the N reception antenna elements, using the plurality of reception signals measured by the receiver in the first period; and
a second complex transfer function calculator that calculates a second complex transfer function by dividing all elements based on the plurality of first complex transfer functions by a direct wave component extracted using one or more elements based on the plurality of first complex transfer functions, the direct wave component having arrived not via the living body from the plurality of reception signals, wherein
the one or more elements used for extraction of the direct wave component include two or more elements respectively corresponding to two or more subcarriers that are adjacent in frequency among the plurality of subcarriers, and
the direct wave component is an average value of one element based on the plurality of first complex transfer functions and the two or more elements.

2. (canceled)

3. (canceled)

4. An estimating device comprising:
a transmission signal generator that generates a multicarrier signal obtained by modulating a plurality of subcarrier signals;
a transmission antenna including M transmission antenna elements, where M is a natural number greater than or equal to 1;
a transmitter that causes the transmission antenna to transmit the multicarrier signal, by processing and outputting the multicarrier signal to the transmission antenna;
a reception antenna including N reception antenna elements, where N is a natural number greater than or equal to 1;
a receiver that measures, for a first period equivalent to a cycle derived from an activity of a living body, a plurality of reception signals which are received by each of the N reception antenna elements and include a reflected signal which is the multicarrier signal transmitted from each of the M transmission antenna elements that has been reflected or dispersed by the living body;
a first complex transfer function calculator that calculates, for each of a plurality of subcarriers to which the plurality of subcarrier signals correspond, a plurality of first complex transfer functions indicating a propagation characteristic between a transmission antenna element and a reception antenna element in each of M×N combinations which are combinations of each of the M transmission antenna elements and each of the N reception antenna elements, using the plurality of reception signals measured by the receiver in the first period; and
a second complex transfer function calculator that calculates a second complex transfer function by dividing all elements based on the plurality of first complex transfer functions by a direct wave component extracted using one or more elements based on the plurality of first complex transfer functions, the direct wave component having arrived not via the living body from the plurality of reception signals, wherein
the one or more elements used for extraction of the direct wave component include two or more elements respectively corresponding to two or more subcarriers that are adjacent in frequency among the plurality of subcarriers, and
the direct wave component is a direct wave transfer function which is a channel component of a direct wave and is calculated by multiplying an eigenvector by the plurality of first complex transfer functions, the eigenvector being, among pairs of eigenvalues and eigenvectors calculated by performing Eigendecomposition of a correlation matrix of one element based on the plurality of first complex transfer functions and the two or more elements, an eigenvector paired with a maximum eigenvalue.

5. The estimating device according to claim 1, further comprising:
a third complex transfer function calculator that calculates a third complex transfer function in which frequency phase errors in the plurality of subcarriers are corrected, based on (i) a distance between the transmission antenna element and the reception antenna element and (ii) the plurality of first complex transfer functions.

6. The estimating device according to claim 1, further comprising:
a third complex transfer function calculator that calculates a third complex transfer function in which frequency phase errors in the plurality of subcarriers are corrected, based on (i) a distance between the transmission antenna element and the reception antenna element and (ii) a reference complex transfer function matrix which is a complex transfer function measured for a second period.

7. The estimating device according to claim 5, further comprising:
a living body correlation matrix calculator that successively records a plurality of third complex transfer functions, each of which is the third complex transfer function, in time series which is an order in which the plurality of third complex transfer functions are measured, and calculates a living body correlation matrix by extracting a component related to the living body from the plurality of third complex transfer functions; and
a ranging unit that estimates, using the living body correlation matrix, a third distance that is a sum of a first distance between the transmission antenna and the living body, and a second distance between the reception antenna and the living body.

8. The estimating device according to claim 7, wherein
the living body correlation matrix calculator:
calculates a correlation matrix of the third complex transfer function;
calculates a first vector by vectorizing a lower triangular matrix excluding diagonal terms of the correlation matrix; and
calculates the living body correlation matrix by extracting a component related to the living body from the first vector.

9. The estimating device according to claim 7, wherein
the ranging unit estimates the third distance using any one of a multiple signal classification (MUSIC) method, a beamformer method, or a Capon method.

10. The estimating device according to claim 7, wherein
at least one of the M transmission antenna elements or the N reception antenna elements includes two antenna elements, and
the estimating device further comprises a position estimator that calculates two or more ellipses in which positions of the M transmission antenna elements and the N reception antenna elements are foci and a length of a major axis is the third distance, and estimates an intersection of the two or more ellipses as a position of the living body.

11. An estimating method comprising:
generating a multicarrier signal obtained by modulating a plurality of subcarrier signals;
causing a transmission antenna to transmit the multicarrier signal, by processing and outputting the multicarrier signal to the transmission antenna, the transmission antenna including M transmission antenna elements, where M is a natural number greater than or equal to 1;
measuring, for a first period equivalent to a cycle derived from an activity of a living body, a plurality of reception signals which are received by each of N reception antenna elements included in a reception antenna and which include a reflected signal which is the multicarrier signal transmitted from each of the M transmission antenna elements that has been reflected or dispersed by the living body, where N is a natural number greater than or equal to 1, where at least one of M or N is greater than or equal to 2;
calculating, for each of a plurality of subcarriers to which the plurality of subcarrier signals correspond, a plurality of first complex transfer functions indicating a propagation characteristic between a transmission antenna element and a reception antenna element in each of M×N combinations which are combinations of each of the M transmission antenna elements and each of the N reception antenna elements, using the plurality of reception signals measured in the first period; and
calculating a second complex transfer function by dividing all elements based on the plurality of first complex transfer functions by a direct wave component extracted using one or more elements based on the plurality of first complex transfer functions, the direct wave component having arrived not via the living body from the plurality of reception signals, wherein
the one or more elements used for extraction of the direct wave component include two or more elements respectively corresponding to two or more subcarriers that are adjacent in frequency among the plurality of subcarriers, and
the direct wave component is a direct wave transfer function which is a channel component of a direct wave and is calculated by multiplying an eigenvector by the plurality of first complex transfer functions, the eigenvector being, among pairs of eigenvalues and eigenvectors calculated by performing Eigendecomposition of a correlation matrix of one element based on the plurality of first complex transfer functions and the two or more elements, an eigenvector paired with a maximum eigenvalue.

12. A non-transitory computer-readable recording medium having recorded thereon a computer program for causing a computer to execute the estimating method according to claim 11.
